(19) United States
(12) Patent Application Publication
(10) Pub. No.: US 2015/0006312 A1
(43) Pub. Date: Jan. 1, 2015

(54) SYSTEM AND METHOD FOR CONDUCTING AN ONLINE AUCTION

(71) Applicant: WINGIT IT, LLC, GERMANTOWN, MD (US)

(72) Inventor: STEVEN RANDALL MURRAY, GERMANTOWN, MD (US)

(73) Assignee: WINGIT IT, LLC, GERMANTOWN, MD (US)

(21) Appl. No.: 14/298,174

(22) Filed: Jun. 6, 2014

Related U.S. Application Data
(63) Continuation-in-part of application No. 13/933,066, filed on Jul. 1, 2013, now Pat. No. 8,781,913.

(51) Int. Cl. G06Q 30/08

(52) U.S. Cl. CPC G06Q 30/08
USPC 705/26.3

(57) ABSTRACT

In one implementation, an online auction for a cohort of users that have a pre-established association with a scheduled experience may be provided. The cohort associated with the scheduled experience may be determined. The cohort may comprise a plurality of users that have a pre-established association with the scheduled experience. Auction information related to an auction for one or more items may be received. One or more users of the cohort may be associated as participants of the auction. The auction may be conducted for the one or more items.

### CROSS-REFERENCE TO RELATED APPLICATION

This application is a continuation-in-part of U.S. patent application Ser. No. 13/933,066, filed on Jul. 1, 2013, the content of which is incorporated herein in its entirety by reference.

### FIELD OF THE INVENTION

The invention relates to a system and method for conducting an online auction, including, for example, conducting an online auction via a social networking forum for a cohort of users that have a pre-established association with an experience scheduled to occur at a predetermined time, a predetermined date, and/or a predetermined location.

### BACKGROUND OF THE INVENTION

Generally speaking, individuals often provide items for sale via online auction systems. Conventional online auction systems may conduct an electronic auction of the item on behalf of a seller of the item. For example, an online auction system may make the item available for bidding by members of the general public and facilitate provision of the item from the seller and a winning bidder.

Conventional online auction systems have various limitations and drawbacks. For example, an individual supplying an item for auction may be unable to identify other individuals who may want the item and notify them that the item is available via the online auction system. Similarly, an individual who is interested in acquiring a particular item or perusing potential items of interest that are relevant to the individual may have to search a conventional online auction system and possibly wade through irrelevant items to determine whether the particular item is available or otherwise find potential items of interest.

Further, conventional online auction systems do not provide enough control over the individuals who may participate in the auction. For example, while some online auction systems may allow the individual providing the item to block particular individuals from participating in the auction, they typically do not facilitate targeting potentially interested individuals to participate in the auction.

Conventional online auction systems suffer from these and other drawbacks.

### SUMMARY OF THE INVENTION

The invention solving these and other drawbacks of conventional systems relates to a system and method for conducting an online auction via a social networking forum for a cohort of users that have a pre-established association with an experience scheduled to occur at a predetermined time, a predetermined date and/or a predetermined location. For example, a system may be configured to provide a social networking forum that facilitates social networking communications amongst the members of the forum combined with auction capabilities that provide items that may be relevant to its members. The social networking forum may be available for users in the cohort to join as members. As such, the members of the social networking forum have a pre-established association with one another because they are scheduled to share the same experience.

The social networking forum may provide a supplier of an item for auction with a target audience (e.g., members of a forum) that may be interested in the item by virtue of their pre-established association with an experience. Similarly, from the perspective of a given member of the forum, the system may provide an auction that includes items that may be of interest to the given member. For example, an airline may supply items for auction via a social networking forum for passengers scheduled on one of the airline's flights. The supplied items may include items that would be relevant to the passengers of the flight such as, for example, an upgraded seat, a meal voucher, earphones, entertainment, and/or other products and/or services that may be of interest to a passenger of the flight.

The system may be configured to receive an identification of an item to be auctioned from various suppliers. A supplier may include a provider of the experience, a member of the forum, a third party who has access to the social networking forum, and/or other entities. For example, the system may receive, from the supplier, auction identification information that includes the identification of the item and/or parameters by which to conduct the auction. In some implementations, the system may receive an identification of members who should be included as a participant in the auction. In this manner, the supplier may identify and/or target members who should be offered a chance to participate in the auction.

The system may be configured to receive from a member a specification of one or more conditions that, when satisfied, alert the member that a given item is to be auctioned. The one or more conditions may identify a particular item, a type of item, and/or other condition that may be specified by the member. In other words, the conditions may serve as a wish list of one or more items and/or features of an item. In this manner, when an item is up for auction that satisfies the conditions, the member may be notified.

The system may provide a notification to the members of the forum that may participate in the auction that the item will be auctioned. The notification may be provided via the social networking forum and/or other communication channels. The system may conduct the auction on behalf of the supplier by receiving bids and determining a winning bid or that no winning bid has been received. The system may facilitate the provision of the item by the supplier in relation to the winning bid and/or payment from the winning bidder to the supplier. Throughout the auction and/or afterward, the system may provide notifications via the social networking forum to the members of the forum that may be participating in the auction to provide status updates related to the auction.

In some implementations, a provider of the shared experience may manage the social networking forum for the cohort of users and/or the auction capabilities of the social networking forum. For example, a provider may restrict participation by other suppliers in the social networking forum. The system may allow a provider to restrict which entities may supply items to be auctioned, may restrict the items offered for auction via the social networking forum, may restrict the manner in which the auction is conducted, may restrict the manner in which the item is provided from the supplier to the winning bidder, and/or may provide other restrictions related to the auction of items via the social networking forum.

Various entities interacting with the system may benefit. A supplier of a given item may benefit by leveraging a given social networking forum to target items to be auctioned to particular members who may be interested in the item. Because the given social networking forum is related to a shared experience, at least some of the members of the forum may share similar interests or otherwise have a shared interest in the given item because of its relation to the shared experience. Furthermore, a supplier may identify particular members or groups of members who should be able to participate in the auction, thereby exercising enhanced control over the auction.

A member who wishes to bid on an auction item may benefit by being provided with notifications of items to be auctioned that may be relevant to the member and/or searching items to be auctioned that are related to the social networking forum, instead of having to wade through several items that may not be of interest to the member. For example, if one member submits an offer to sell an item that is relevant to other members, the other members may be notified that the item is being auctioned so that the other members may submit bids for the item and/or modify their previous bids for the item. Furthermore, the member who wishes to bid on the auction item may have enhanced communication capabilities before, during, and/or after the auction with the supplier of the auction item and other members who wish to bid on the auction item.

A provider of the shared experience (who may also be the supplier of an auction item) may benefit from using the system by leveraging the communication and auction capabilities to provide a more complete experience for its patrons. For example, a provider of the shared experience may partner with or otherwise provide the system to its patrons so that the patrons may be able to sell and/or buy items that may be related to the shared experience.

The system for conducting an online auction via a social networking forum for a cohort of users may comprise a computing device including a physical processor configured to perform some or all of a functionality of a plurality of modules. In some implementations, the computing device may comprise a non-transitory, tangible computer-readable storage medium with an executable program stored thereon, wherein the program instructs a microprocessor to perform some or all of the functionality of the plurality of modules. The plurality of modules may include, for example, a forum management module, an auction submission module, an auction management module, a provider management module, a third party management module, a role-based permissions module, a storage module, a reporting module, and/or other modules.

The forum management module may be configured to provide a social networking forum for the cohort and facilitate social networking communications between one or more members of the forum. The auction submission module may be configured to receive auction identification information for an item for auction. The auction management module may be configured to conduct an auction of an item via the forum by presenting items for auction and facilitating bidding and winning an auction item by one or more members of the forum. The provider management module may be configured to facilitate registration of a provider of a shared experience, facilitate management of an auction by the provider, and/or other functionality related to managing the shared experience. The third party management module may be configured to facilitate registration of third parties with the system, provide an interface for third parties to present content to a forum, facilitate management of an auction by a third party, and/or otherwise manage the access of third parties to members and/or content of the forum. The role-based permission module may be configured to tailor access to the system based on roles of various users including, for example, a role in the system, a role in a cohort, a role in an auction, and/or other roles. The storage module may be configured to store information related to system usage, one or more cohorts, one or more forums, one or more auctions, and/or other information related to the system. The reporting module may be configured to facilitate analysis and report information related to system usage, one or more cohorts, one or more forums, one or more auctions, and/or other information related to the system.

The forum management module may be configured to provide a plurality of social networking forums for a respective plurality of cohorts. The forum management module may allow a user of a cohort to join a social networking forum for the cohort as a member of the forum. A cohort of users may comprise, for example, one or more persons that have a pre-established association with an experience scheduled to occur at a predetermined time, a predetermined date, and/or a predetermined location. Experiences may include taking a same flight, taking a same bus, taking a same train, attending a same sporting event, attending a same concert, attending a same play, attending a same art show, attending a same exhibition, attending a launch of a same product (e.g., a movie, an electronic gadget, and/or other product) and/or other shared experience between a plurality of persons that is scheduled to occur at a predetermined time, a predetermined date, and/or a predetermined location. A user may be associated with an experience by buying a ticket for the experience, registering for the experience, and/or otherwise performing an action that indicates that the user plans to engage in the experience.

A cohort may be identified by a unique identifier, which may include a human-readable identifier and/or other type of identifier. For an individual cohort, the forum management module may be configured to store the unique identifier, an identification of the experience shared by the users of the cohort, a predetermined time at which the experience is expected to occur, a predetermined date on which the experience is expected to occur, a predetermined location at which the experience is expected to occur, a type of the experience, a sub-type of the experience, one or more users of the cohort, contact information for one or more users of the cohort, a set of authorized users for the cohort, information related to a provider of the shared experience, and/or other information related to the cohort. A type of experience may comprise, for example, transportation, sporting event, entertainment event, family event, art event, and/or other type of shared experience between a plurality of persons with a pre-established connection to the experience that is scheduled to occur at a predetermined time, a predetermined date and a predetermined location. A type of experience may include a plurality of sub-types, where the sub-types are delineated by one or more values associated with a set of one or more respective items of related information.

The forum management module may facilitate social networking communications between one or more members of a social networking forum. For example, the forum management module may facilitate sharing items of content via the social networking forum. In some implementations, one or more identifiers may be associated and/or included with an item of content. An identifier may identify, for example, a member of the forum, a time, a place, a location, another forum, a third party identifier, a social media tag, and/or other identifier for the item of content. In some implementations, the member sharing the content with the forum may indicate that some or all portions of the item of content should be shared, may indicate whether the content may be shared to the general public, may indicate other members of the forum with whom the portions of the item are shared, and/or may otherwise restrict sharing of the item of content. In some implementations, the forum management module may facilitate the sharing of at least some of the content items over one or more social media platforms. In some implementations, the forum management module may allow a member to tag or link an entity such as a person, place, and/or location to an item of content.

The auction submission module may be configured to receive auction identification information for an item for auction. The auction identification information may include an identification of the item, a minimum bid for the item, information related to the supplier of the item, information related to one or more end conditions which, when met, end the auction, information related to a date and/or time at which to begin the auction, a type of auction, and/or other parameters by which to conduct the auction. For example, a type of auction may comprise an auction in which the highest bid wins, an auction in which the lowest bid wins, a dutch auction, a sealed bid auction, a vickrey auction, an auction with a ‘buy now’ option, a Walrasian auction (e.g., an auction in which a current proposed price for an auction item is progressively increased or reduced based on bids of buyers and sellers), and/or other type of auction. Information related to end conditions which might end the auction may comprise, for example, a predetermined time period after which the auction begins, a predetermined time period after a bid is received without a subsequent bid being received, an occurrence of the shared experience of the cohort, a loss of value of the item, and/or other information related to one or more conditions which may end an auction. In some implementations, the auction submission module may receive an identification of members who should be included as a participant in the auction.

In some implementations, the auction submission module may impose restrictions on an auction of an item. The auction submission module may receive the restrictions from a provider of the shared experience who may manage the forum, from a system administrator, and/or another entity able to control an auction conducted via the forum. A restriction may regulate an item supplied, a type of item, a quantity of item, a time and/or date of the auction for an item, and/or other parameter of the auction. In some implementations, a provider of the shared experience may be able to supply a same or different set of restrictions than another entity able to control an auction conducted via the forum.

Based on the received auction information, the auction submission module may generate an identifier for the auction. For example, the auction submission module may be configured to generate an identifier for the auction based on one or more of an identifier for the item being auctioned, a time and/or date on which the auction is to be conducted, a supplier of the item for auction, and/or other information related to the auction for the item.

One or more types of suppliers may provide an item for auction and auction information. A type of supplier may be a member of the forum, a provider of the shared experience, a third party with access to the social networking, and/or other type of entity that provides the item. In some implementations, a supplier may determine relevant and/or timely items to provide for auction to members of the forum based on the shared experience.

Responsive to the auction submission module receiving auction information and generating a unique identifier for the auction, the auction management module may be configured to conduct an auction for the item. The auction management module may be configured to conduct an auction by presenting items for auction and facilitating bidding and winning an auction item by one or more members of the forum. The auction may be conducted by performing one or more auction events via the social networking forum. Auction events may comprise, for example, receiving auction information to begin an auction, providing notification via the forum that an item is available for auction, providing notification via the forum that one or more bids for auction have been received, ending the auction, awarding the item to a winning bidder, and/or other events related to an auction.

The auction may be conducted as part of a content feed of the social networking forum or separate from the content feed. The content feed may comprise a communication channel via which members of the forum post information to be shared. In some implementations, some of the auction events may be shared via the content feed of the forum (e.g., providing notifications, ending the auction, and/or other auction events that involve more than one member), while other auction events may be conducted separately from the content feed (e.g., receiving auction information, awarding the item, and/or other auction events that involve only one member).

In some implementations, the auction management module may comprise an auction initiation module, a bid management module, an auction ending module, an award management module, and/or other computer program modules related to conducting an auction. The auction initiation module may initiate an auction responsive to the auction submission module receiving auction information and generating a unique identifier for the auction. The bid management module may be configured to receive bids from one or more members, facilitate communication during the auction, and/or otherwise manage bidding in the auction. The auction ending module may be configured to end the auction based on one or more end conditions for the auction being met. The award management module may be configured to facilitate provision of the item to the member who won the auction, facilitate return the item to the supplier responsive to no bids being received during the auction, and/or otherwise manage the provision of the item at the end of the auction.

The auction initiation module may initiate an auction responsive to the auction submission module receiving auction information and generating a unique identifier for the auction. In some implementations, the auction initiation module may be configured to set a time limit, identify one or more accepted types of presenters of an auction item (e.g., a member of the forum, an administrator of the system, a third party, a provider of the shared experience, and/or other author), identify one or more accepted types of bidders (e.g., a member of the forum, an administrator of the system, a third party, a provider of the shared experience, and/or other author), identify a delivery method of the auction item, set a minimum bid, set a maximum bid, set a maximum number of bids per member, and/or other set other restrictions related to the auction. One or more values for the restrictions may be default values. The auction initiation module may be configured to revise a value for a restriction responsive to receiving input related to the restriction from the supplier of the item for auction.

The auction initiation module may associate some or all of the members of the forum with the auction. The auction initiation module may select one or more members to associate with the auction based on preferences of the supplier of the item for auction, preferences of individual members of the cohort, and/or based on other information relating to the auction. For example, the supplier may specify one or more members of the forum to be notified of the auction. In another example, one or more members of the forum may indicate that they want to be notified of an auction occurring, of an auction for a type of item, of an auction for a particular item, of an auction for an item provided by a type of supplier, of an auction for an item provided by a particular supplier, and/or of an auction that meets one or more other conditions.

In some implementations, the auction initiation module may notify the members of the forum of the initiation of the auction via the content feed of the social networking forum or via a communication channel of the forum separate from the content feed. Responsive to the auction initiation module associating a subset of members of the forum with the auction, where the subset comprises less than all of the members of the forum, the auction initiation module may send a private chat message to individual members being notified.

The bid management module may be configured to receive bids from one or more members, facilitate communication during the auction, and/or otherwise manage bidding in the auction. The bid management module may be configured to manage bids based on the type of auction being conducted. The bid management module may be configured to display the best bid received during the auction (or the minimum bid, if no bids have been received). The bid management module may also be configured to display information related to the member that submitted the best bid, a time left for bidding, a time left for the auction, a supplier of the item for auction, and/or other information related to the auction. Responsive to receiving a bid from a member of the forum, the bid management module may determine whether the received bid is better than the current best bid received (or the minimum bid, if no bids have been received) based on the type of auction being conducted. Responsive to determining that the received bid is better, the bid management module may update the current best bid received and/or the member with the current best bid.

The bid management module may also be configured to facilitate chat communications between members for the auction. In some implementations, the bid management module may provide a separate communication channel via the forum for the auction, using which members participating in the auction may engage in social networking communications.

The auction ending module may be configured to end the auction based on one or more end conditions for the auction being met. End conditions may comprise, for example, a predetermined time period after which the auction begins, a predetermined time period after a bid is received without a subsequent bid being received, an occurrence of the shared experience of the cohort, a loss of value of the item, and/or other information related to one or more conditions which may end an auction. The auction ending module may monitor the auction to determine whether one or more of the end conditions are met. In some implementations, auction ending module may be configured to provide an alert to the members that satisfaction of an end condition is imminent (e.g., the auction will end soon). For example, an end condition may specify that when a given bid is received and no subsequent bid is received within a predetermined time period, the auction will terminate and the given bid will be deemed the winning bid. In the foregoing example, the auction ending module may provide an alert to the members participating in the auction at a predefined alert time before the end condition is met. The alert may indicate that the auction will end at the predetermined time unless a subsequent bid is received. The auction ending module may provide the alert in a same or similar way that the auction provides notifications to the members participating in the auction.

The award management module may be configured to cause the item to be provided to the member who won the auction, cause the item to be returned to the supplier responsive to no winning or otherwise successful bids being received during the auction, and/or otherwise manage the provision of the item at the end of the auction. Responsive to the auction ending (e.g., one or more of the end conditions of the auction being met, and/or other ending of the auction), the award management module may determine whether any bids were received during the auction. Responsive to one or more bids being received, the award management module may provide the supplier with information relating to the member that submitted the bid that won the auction and may facilitate provision of the item to the member that submitted the bid that won the auction. In some implementations, the auction identification information associated with the item may specify how the item is provided. In some implementations, the award management module may facilitate communication between the member with the winning bid and the supplier to decide delivery terms. The award management module may also facilitate payment for the item by the member with the winning bid.

The provider management module may be configured to facilitate registration of a provider of a shared experience, facilitate management of an auction by the provider, and/or other functionality related to managing the shared experience. The provider management module may be configured to allow a provider of a shared experience to control access and participation by members, third parties, administrators of the system, and/or other individuals in the auction.

The provider management module may also be configured to allow a provider to restrict the auctions available via the forum. For example, the provider management module may be configured to allow a provider to authorize auctions for particular types of items, for particular items, from particular third parties, from particular members of the forum, and/or auctions with other characteristics. The provider management module may be configured to receive one or more restrictions for auctions conducted via the forum. For example, the provider management module may be configured to receive restrictions on: an item that may be provided, the type of item that may be provided, who may access the forum, who may access the auction, a time and/or date on which the auction may be conducted, delivery terms for the item, and/or other restrictions related to an auction.

In some implementations, a same provider may be associated with a plurality of shared experiences (and a plurality of respective cohorts). The provider management module may be configured to allow a provider to manage some or all associated auctions in a same way or on a case-by-case individual basis. For example, the restrictions provided may vary based on depending on type of supplier, particular supplier, cohort, and/or other entity involved with the auction or the forum. Examples of providers include airports, airlines, transportation companies, entertainment venues, sports arenas, sports leagues, and/or other entities that provide shared experiences.

The third party management module may be configured to facilitate registration of third parties with the system, facilitate management of an auction by a third party, and/or otherwise manage the access of third parties to members and/or the auction. In some implementations, the third party management module may be configured to allow a third party to submit an item for auction in a forum. In some implementations, the third party management module may be configured to allow a third party to participate in an auction in a manner the same or similar to a member of the forum. In some implementations, the third party management module may be configured to restrict participation by a third party in a forum. The third party management module may be configured to require a third party to pay a transaction fee for access to the system, for particular types of access to a forum, to provide an item for auction, to bid on an item in an auction, and/or for other types of participation in the auction.

The role-based permission module may be configured to tailor access to the system based on roles of various users including, for example, a role in the system, a role in a forum, a role as a third party, a role as a provider of the shared experience, a role in an auction, and/or other roles. The one or more roles may include system-level roles, forum-level roles, auction-level roles, third party level roles, and/or other types of roles. System-level roles may grant access to various system features such as for example, access to one or more modules, access to content stored at a storage module, and/or other access to system features. System-level roles may be configured, for example, to manage storage of forum information, access to third parties, and/or other system-level features. Different system-level roles may be granted that provide access to different system features. Forum-level roles may grant access to various forum features such as, for example, access to the content shared by the forum, access to contact information of members of the forum, access to auctions conducted via the forum, and/or other access. Different forum-based roles may be granted that provide access to different forum features. Auction-level roles may grant access to various forum features such as, for example, access to an auction, access to bid on an item in an auction, access to communicate with a supplier and/or other members participating in an auction, access to the content shared via a communication channel for an auction, and/or other access. Different auction-based roles may be granted that provide access to different auction features. The role-based permissions module may maintain a plurality of roles, including, for example, administrator, member, third party, provider of shared experience, and/or other roles.

The storage module may be configured to store information related to system usage, one or more cohorts, one or more forums, one or more auctions, and/or other system information. For example, the storage information may be configured to store information related to cohorts, forums, auctions, third parties, and/or other information obtained, accessed, and/or processed via the system. The storage module may further store content developed and/or shared via the system.

The reporting module may be configured to facilitate analysis and report information related to system usage, one or more cohorts, one or more forums, one or more auctions, and/or other system information. The reporting module may also be configured to prepare and/or display statistics and/or reports regarding the information related to system usage, cohort information, forum content, auction content, third party access, and/or other information obtained, accessed, and/or processed by the system. For example, the reporting module may prepare and/or display a report describing average selling price for items auctioned via a forum.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a block diagram of an exemplary system for conducting an auction via social networking forum for a cohort of users, according to various implementations of the invention.

FIG. 2 illustrates a process for conducting an online auction via a social networking forum for a cohort of users, according to various implementations of the invention.

FIG. 3 illustrates an exemplary screenshot of a template by which a user may access the system, according to various implementations of the invention.

FIG. 4 illustrates a process for participating in an auction conducted via a social networking forum associated with a cohort of users, according to various implementations of the invention.

FIG. 5 illustrates an exemplary screenshot of a template by which members of a forum may participate in an auction for an item, according to various implementations of the invention.

FIG. 6 illustrates a process for conducting an auction via social networking forum for a cohort of users, according to various implementations of the invention.

FIG. 7 illustrates an exemplary screenshot of a template by which a provider of a shared experience may participate in an auction for an item, according to various implementations of the invention.

FIG. 8 illustrates a process for conducting an auction via social networking forum for a cohort of users, according to various implementations of the invention.

FIG. 9 illustrates an exemplary screenshot of a template by which a third party may participate in an auction for an item, according to various implementations of the invention.

FIG. 10 illustrates an exemplary user interface for participating in an auction, according to various implementations of the invention.

FIG. 11 illustrates an exemplary user interface for enabling a user to view current bids of the user, offers for the user, and transaction history, according to various implementations of the invention.

### DETAILED DESCRIPTION

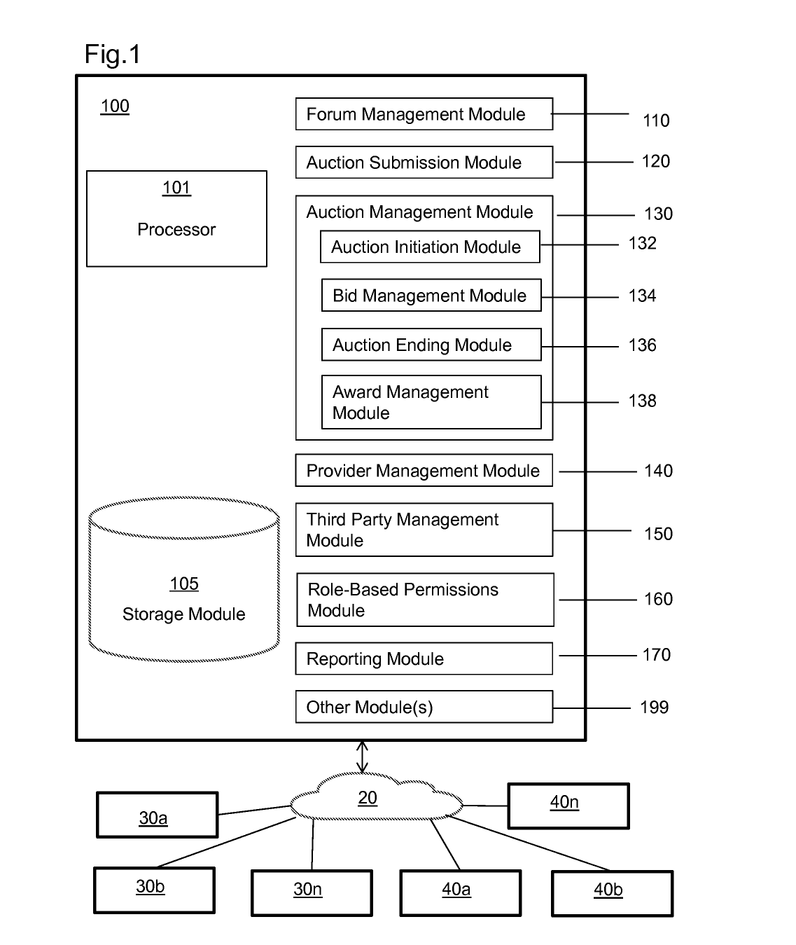

FIG. 1 illustrates a diagram of a system 10 for conducting an auction via social networking forum for a cohort of users, according to an implementation of the invention. The system 10 may include a network 20, a computing device 100, one or more user computing devices 30a, 30b, . . . , 30n, one or more provider computing devices 40a, 40b, . . . , 40n, and/or other components. The computing device 100 may include a processor 101 configured to perform some or all of a functionality of a plurality of modules. In some implementations, the computing device 100 may comprise a non-transitory, tangible computer-readable storage medium with an executable program stored thereon, wherein the program instructs a microprocessor to perform some or all of the functionality of the plurality of modules. The plurality of modules may include, for example, forum management module 110, an auction submission module 120, an auction management module 130, a provider management module 140, a third party management module 150, a role-based permissions module 160, a storage module 105, a reporting module 170, and/or other modules. The system 10 may be configured to provide a social networking forum that facilitates social networking communications amongst the members of the forum combined with auction capabilities that provide items that may be relevant to its members. The social networking forum may be available for users in a cohort to join as members. As such, the members of the social networking forum have a pre-established association with one another because they are scheduled to share the same experience.

The forum management module 110 may be configured to provide a social networking forum for the cohort and facilitate social networking communications between one or more members of the forum. The auction submission module 120 may be configured to receive auction identification information for an item for auction. The auction management module 130 may be configured to conduct an auction of an item via the forum by presenting items for auction and facilitating bidding and winning an auction item by one or more members of the forum. The provider management module 140 may be configured to facilitate registration of a provider of a shared experience, facilitate management of an auction by the provider, and/or other functionality related to managing the shared experience. The third party management module 150 may be configured to facilitate registration of third parties with the system, provide an interface for third parties to present content to a forum, facilitate management of an auction by a third party, and/or otherwise manage the access of third parties to members and/or content of the forum. The role-based permission module 160 may be configured to tailor access to the system based on roles of various users including, for example, a role in the system, a role in a cohort, a role in an auction, and/or other roles. The storage module 105 may be configured to store information related to system usage, one or more cohorts, one or more forums, one or more auctions, and/or other information related to the system. The reporting module 170 may be configured to facilitate analysis and report information related to system usage, one or more cohorts, one or more forums, one or more auctions, and/or other information related to the system.

The forum management module 110 may be configured to provide a plurality of social networking forums for a respective plurality of cohorts. The forum management module 110 may allow a user of a cohort to join a social networking forum for the cohort as a member of the forum. A cohort of users may comprise, for example, one or more persons that have a pre-established association with an experience scheduled to occur at a predetermined time, a predetermined date, and/or a predetermined location. Experiences may include taking a same flight, taking a same bus, taking a same train, attending a same sporting event, attending a same concert, attending a same play, attending a same art show, attending a same exhibition, attending a launch of a same product (e.g., a movie, an electronic gadget, and/or other product) and/or other shared experience between a plurality of persons that is scheduled to occur at a predetermined time, a predetermined date, and/or a predetermined location. A user may be associated with an experience by buying a ticket for the experience, registering for the experience, and/or otherwise performing an action that indicates that the user plans to engage in the experience.

A cohort may be identified by a unique identifier, which may include a human-readable identifier and/or other type of identifier. For an individual cohort, the forum management module 110 may be configured to store the unique identifier, an identification of the experience shared by the users of the cohort, a predetermined time at which the experience is expected to occur, a predetermined date on which the experience is expected to occur, a predetermined location at which the experience is expected to occur, a type of the experience, a sub-type of the experience, one or more users of the cohort, contact information for one or more users of the cohort, a set of authorized users for the cohort, information related to a provider of the shared experience, and/or other information related to the cohort. A type of experience may comprise, for example, transportation, sporting event, entertainment event, family event, art event, and/or other type of shared experience between a plurality of persons with a pre-established connection to the experience that is scheduled to occur at a predetermined time, a predetermined date and a predetermined location. A type of experience may include a plurality of sub-types, where the sub-types are delineated by one or more values associated with a set of one or more respective items of related information.

The forum management module 110 may facilitate social networking communications between one or more members of a social networking forum. For example, the forum management module 110 may facilitate sharing items of content via the social networking forum. In some implementations, one or more identifiers may be associated and/or included with an item of content. An identifier may identify, for example, a member of the forum, a time, a place, a location, another forum, a third party identifier, a social media tag, and/or other identifier for the item of content. In some implementations, the member sharing the content with the forum may indicate that some or all portions of the item of content should be shared, may indicate whether the content may be shared to the general public, may indicate other members of the forum with whom the portions of the item are shared, and/or may otherwise restrict sharing of the item of content.

In some implementations, the forum management module 110 may facilitate the sharing of at least some of the content items over one or more social media platforms. In some implementations, the forum management module 110 may allow a forum member to tag or link an entity such as a person, place, and/or location to an item of content. For example, one or more social media platforms with which a forum member is associated may search for the entity and may present potential entities that match the tagged or linked entity to the forum member. The forum member may share the item of content with one or more of the potential entities. For example, the forum member may share an item of content on a social media page or via a social media account of the potential entity. In another example, the forum management module 110 may facilitate exporting of items of content to a social media platform. For example, the forum management module 110 may facilitate the inclusion of hashtags with content such that the content may be shared via a social media platform such as TWITTER, INSTAGRAM, FACEBOOK, and/or other social media platforms that recognize hashtags.

In some implementations, the forum management module 110 may facilitate creation and management of a forum for a cohort of users in a manner the same or similar to the auctions described in U.S. patent application Ser. No. 13/933,045 (entitled “System and Method for Creating an Ad Hoc Social Networking Forum for a Cohort of Users”, filed Jul. 1, 2013, and issued as U.S. Pat. No. 8,751,407) which is hereby incorporated by reference in its entirety.

The auction submission module 120 may be configured to receive auction identification information for an item for auction. The auction identification information may include an identification of the item, a minimum bid for the item, information related to the supplier of the item, information related to one or more end conditions which, when met, end the auction, information related to a date and/or time at which to begin the auction, a type of auction, and/or other parameters by which to conduct the auction. For example, a type of auction may comprise an auction in which the highest bid wins, an auction in which the lowest bid wins, a dutch auction, a sealed bid auction, a vickrey auction, an auction with a ‘buy now’ option, a Walrasian auction (e.g., an auction in which a current proposed price for an auction item is progressively increased or reduced based on bids of buyers and sellers), and/or other type of auction. Information related to end conditions which might end the auction may comprise, for example, a predetermined time period after which the auction begins (e.g., a set number of days after the auction begins, a set number of hours after the auction begins, a remaining predetermined duration of a scheduled experience with which participants of the auction are associated, etc.), a predetermined time period after a bid is received without a subsequent bid being received (e.g., a set number of hours after the receipt of the bid, a set number of minutes after the receipt of the bid, etc.), an occurrence of the shared experience of the cohort (e.g., an initiation of the shared experience, an ending of the shared experience, etc.), a loss of value of the item, and/or other information related to one or more conditions which may end an auction. In some implementations, the auction submission module 120 may receive an identification of members who should be included as a participant in the auction.

In some implementations, the auction submission module 120 may impose restrictions on an auction of an item. The auction submission module 120 may receive the restrictions from a provider of the shared experience who may manage the forum, from a system administrator, and/or another entity able to control an auction conducted via the forum. A restriction may regulate an item supplied, a type of item, a quantity of item, a time and/or date of the auction for an item, and/or other parameter of the auction. In some implementations, a provider of the shared experience may be able to supply a same or different set of restrictions than another entity able to control an auction conducted via the forum.

Based on the received auction information, the auction submission module 120 may generate an identifier for the auction. For example, the auction submission module 120 may be configured to generate an identifier for the auction based on one or more of an identifier for the item being auctioned, a time and/or date on which the auction is to be conducted, a supplier of the item for auction, and/or other information related to the auction for the item.

One or more types of suppliers may provide an item for auction and auction information. A type of supplier may be a member of the forum, a provider of the shared experience, a third party with access to the social networking, and/or other type of entity that provides the item. In some implementations, a supplier may determine relevant and/or timely items to provide for auction to members of the forum based on the shared experience.

Responsive to the auction submission module 120 receiving auction information and generating a unique identifier for the auction, the auction management module 130 may be configured to conduct an auction for the item. The auction management 130 may be configured to conduct an auction by presenting items for auction and facilitating bidding and winning an auction item by one or more members of the cohort. The auction may be conducted by performing one or more auction events via the social networking forum. Auction events may comprise, for example, receiving auction information to begin an auction, providing notification via the forum that an item is available for auction, providing notification via the forum that one or more bids for auction have been received, ending the auction, awarding the item to a winning bidder, and/or other events related to an auction.

The auction may be conducted as part of a content feed of the social networking forum or separate from the content feed. The content feed may comprise a communication channel via which members of the forum post content to be shared. In some implementations, some of the auction events may be shared via the content feed of the forum (e.g., providing notifications, ending the auction, and/or other auction events that involve more than one member), while other auction events may be conducted separately from the content feed (e.g., receiving auction information, awarding the item, and/or other auction events that involve only one member).

In some implementations, the auction management 130 may comprise an auction initiation module 132, a bid management module 134, an auction ending module 136, an award management module 138, and/or other computer program modules related to conducting an auction. The auction initiation module 132 may initiate an auction responsive to the auction submission module receiving auction information and generating a unique identifier for the auction. The bid management module 134 may be configured to receive bids from one or more members, facilitate communication during the auction, and/or otherwise manage bidding in the auction. The auction ending module 136 may be configured to end the auction based on one or more end conditions for the auction being met. The award management module 138 may be configured to facilitate provision of the item to the member who won the auction, facilitate returning the item to the supplier responsive to no bids being received during the auction, and/or otherwise manage the provision of the item at the end of the auction.

The auction initiation module 132 may initiate an auction responsive to the auction submission module receiving auction information and generating a unique identifier for the auction. In some implementations, the auction initiation module 132 may be configured to set a time limit, identify one or more accepted types of presenters of an auction item (e.g., a member of the forum, an administrator of the system, a third party, a provider of the shared experience, and/or other author), identify one or more accepted types of bidders (e.g., a member of the forum, an administrator of the system, a third party, a provider of the shared experience, and/or other author), identify a delivery method of the auction item, set a minimum bid, set a maximum bid, set a maximum number of bids per member, and/or other set other restrictions related to the auction. One or more values for the restrictions may be default values. The auction initiation module 132 may be configured to revise a value for a restriction responsive to receiving input related to the restriction from the supplier of the item for auction.

The auction initiation module 132 may associate some or all of the members of the forum with the auction. The auction initiation module 132 may select one or more members to associate with the auction based on preferences of the supplier of the item for auction, preferences of individual members of the cohort, and/or based on other information relating to the auction. For example, the supplier may specify one or more members of the forum to be notified of the auction. In another example, one or more members of the forum may indicate that they want to be notified of an auction occurring, of an auction for a type of item, of an auction for a particular item, of an auction for an item provided by a type of supplier, of an auction for an item provided by a particular supplier, and/or of an auction that meets one or more other conditions.

In some implementations, the auction initiation module 132 may notify the members of the forum of the initiation of the auction via the content feed of the social networking forum or via a communication channel of the forum separate from the content feed. Responsive to the auction initiation module 132 associating a subset of members of the forum with the auction, where the subset comprises less than all of the members of the forum, the auction initiation module 132 may send a private chat message to individual members being notified.

The bid management module 134 may be configured to receive bids from one or more members, facilitate communication during the auction, and/or otherwise manage bidding in the auction. The bid management module 134 may be configured to manage bids based on the type of auction being conducted. The bid management module 134 may be configured to display the best bid received during the auction (or the minimum bid, if no bids have been received). The bid management module 134 may also be configured to display information related to the member that submitted the best bid, a time left for bidding, a time left for the auction, a supplier of the item for auction, and/or other information related to the auction. Responsive to receiving a bid from a member of the forum, the bid management module 134 may determine whether the received bid is better than the current best bid received (or the minimum bid, if no bids have been received) based on the type of auction being conducted. Responsive to determining that the received bid is better, the bid management module 134 may update the current best bid received and/or the member with the current best bid.

The bid management module 134 may also be configured to facilitate chat communications between members for the auction. In some implementations, the bid management module 134 may provide a separate communication channel for the auction, via which members participating in the auction may engage in social networking communications.

The auction ending module 136 may be configured to end the auction based on one or more end conditions for the auction being met. End conditions may comprise, for example, a predetermined time period after which the auction begins, a predetermined time period after a bid is received without a subsequent bid being received, an occurrence of the shared experience of the cohort, a loss of value of the item, and/or other information related to one or more conditions which may end an auction. The auction ending module 136 may monitor the auction to determine whether one or more of the end conditions are met. In some implementations, auction ending module 136 may be configured to provide an alert to the members that satisfaction of an end condition is imminent (e.g., the auction will end soon). For example, an end condition may specify that when a given bid is received and no subsequent bid is received within a predetermined time period, the auction will terminate and the given bid will be deemed the winning bid. In the foregoing example, the auction ending module 136 may provide an alert to the members participating in the auction at a predefined alert time before the end condition is met. The alert may indicate that the auction will end at the predetermined time unless a subsequent bid is received. The auction ending module 136 may provide the alert in a same or similar way that the auction provides notifications to the members participating in the auction.

The award management module 138 may be configured to cause the item to be provided to the member who won the auction, cause the item to be returned to the supplier responsive to no winning or otherwise successful bids being received during the auction, and/or otherwise manage the provision of the item at the end of the auction. Responsive to the auction ending (e.g., one or more of the end conditions of the auction being met, and/or other ending of the auction), the award management module 138 may determine whether any bids were received during the auction. Responsive to one or more bids being received, the award management module 138 may provide the supplier with information relating to the member that submitted the bid that won the auction and may facilitate provision of the item to the member that submitted the bid that won the auction. In some implementations, the auction identification information associated with the item may specify how the item is provided. In some implementations, the award management module 138 may facilitate communication between the member with the winning bid and the supplier to decide delivery terms. The award management module 138 may also facilitate payment for the item by the member with the winning bid.

The provider management module 140 may be configured to facilitate registration of a provider of a shared experience, facilitate management of an auction by the provider, and/or other functionality related to managing the shared experience. The provider management module 140 may be configured to allow a provider of a shared experience to control access and participation by members, third parties, administrators of the system, and/or other individuals in the auction.

The provider management module 140 may also be configured to allow a provider to restrict the auctions available via the forum. For example, the provider management module 140 may be configured to allow a provider to authorize auctions for particular types of items, for particular items, from particular third parties, from particular members of the forum, and/or auctions with other characteristics. The provider management module 140 may be configured to receive one or more restrictions for auctions conducted via the forum. For example, the provider management module 140 may be configured to receive restrictions on: an item that may be provided, the type of item that may be provided, who may access the forum, who may access the auction, a time and/or date on which the auction may be conducted, delivery terms for the item, and/or other restrictions related to an auction.

In some implementations, a same provider may be associated with a plurality of shared experiences (and a plurality of respective cohorts). The provider management module 140 may be configured to allow a provider to manage some or all associated auctions in a same way or on a case-by-case individual basis. For example, the restrictions provided may vary based on depending on type of supplier, particular supplier, cohort, and/or other entity involved with the auction or the forum. Examples of providers include airports, airlines, transportation companies, entertainment venues, sports arenas, sports leagues, and/or other entities that provide shared experiences.

The third party management module 150 may be configured to facilitate registration of third parties with the system, facilitate management of an auction by a third party, and/or otherwise manage the access of third parties to members and/or the auction. In some implementations, the third party management module 150 may be configured to allow a third party to submit an item for auction in a forum. In some implementations, the third party management module 150 may be configured to allow a third party to participate in an auction in a manner the same or similar to a member of the forum. In some implementations, the third party management module 150 may be configured to restrict participation by a third party in a forum. The third party management module 150 may be configured to require a third party to pay a transaction fee for access to the system, for particular types of access to a forum, to provide an item for auction, to bid on an item in an auction, and/or for other types of participation in the auction.

As mentioned above, a provider of the experience may wish to supply an item to be auctioned using the social networking forum. For example, a shared experience may include a flight, a provider of the experience may include an airline, and the users in the cohort may include passengers of the flight. The system 10 may provide a social networking forum related to the flight, which may be leveraged by the airline to auction an item to the passengers of the flight. The item to be auctioned may be related to the flight such as an item that can be used during or after the flight, an item related to a departure and/or destination location, and/or other item that the airline would like to auction. Through the social networking forum, the system 10 may notify the members of the forum (e.g., one or more of the passengers) that the airline is offering the item for auction and the passengers may place bids on the item through the social networking forum. In some implementations, a supplier may determine relevant and/or timely items to provide for auction to members of the forum based on the shared experience of the cohort of users for which the forum is provided. Accordingly, a supplier may not need to know any information related to individual members of the forum. By providing an item relevant to the shared experience, a supplier may increase the chance that an item will be bought and/or may obtain a higher price for the item compared to an auction available to the general public.

In another example, a third party that has access to the forum may determine an item to supply for auction to members in the forum. In the foregoing example, third parties may comprise, for example, vendors at the departure and/or destination location, hotels at the destination location, rental car entities at the destination location, and/or other third parties that may be related to the some or all of the shared experience. A member of the forum may also determine an item for auction to other members of the forum based on the shared experience. In some implementations, the item supplied for auction by a supplier may not necessarily be related to the shared experience and/or the social networking forum.

The role-based permission module 160 may be configured to tailor access to the system based on roles of various users including, for example, a role in the system, a role in a forum, a role as a third party, a role as a provider of the shared experience, a role in an auction, and/or other roles. The one or more roles may include system-level roles, forum-level roles, auction-level roles, third party level roles, and/or other types of roles. System-level roles may grant access to various system features such as for example, access to one or more modules, access to content stored at a storage module, and/or other access to system features. System-level roles may be configured, for example, to manage storage of forum information, access to third parties, and/or other system-level features. Different system-level roles may be granted that provide access to different system features. Forum-level roles may grant access to various forum features such as, for example, access to the content shared by the forum, access to contact information of members of the forum, access to auctions conducted via the forum, and/or other access. Different forum-based roles may be granted that provide access to different forum features. Auction-level roles may grant access to various forum features such as, for example, access to an auction, access to bid on an item in an auction, access to communicate with a supplier and/or other members participating in an auction, access to the content shared via a communication channel for an auction, and/or other access. Different auction-based roles may be granted that provide access to different auction features. The role-based permissions module 160 may maintain a plurality of roles, including, for example, administrator, member, third party, provider of shared experience, and/or other roles.

The storage module 105 may be configured to store information related to system usage, one or more cohorts, one or more forums, one or more auctions, and/or other system information. For example, the storage information may be configured to store information related to cohorts, forums, auctions, third parties, and/or other information obtained, accessed, and/or processed via the system. The storage module 105 may further store content developed and/or shared via the system.

The reporting module 170 may be configured to facilitate analysis and report information related to system usage, one or more cohorts, one or more forums, one or more auctions, and/or other system information. The reporting module 170 may also be configured to prepare and/or display statistics and/or reports regarding the information related to system usage, cohort information, forum content, auction content, third party access, and/or other information obtained, accessed, and/or processed by the system. For example, the reporting module 170 may prepare and/or display a report describing average selling price for items auctioned via a forum.

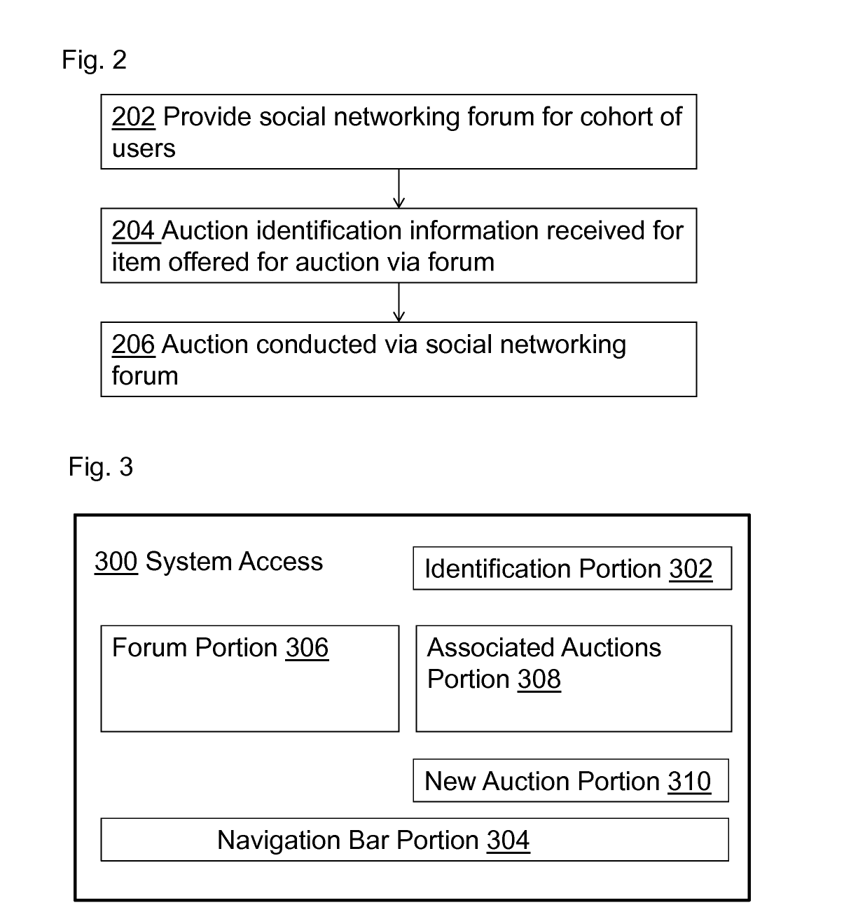

FIG. 2 illustrates a process for facilitating conducting an online auction via a social networking forum for a cohort of users, according to various implementations of the invention. FIG. 3 illustrates an exemplary screenshot of a template by which a user may access the system, according to various implementations of the invention. Processing will be described with respect to FIG. 2 in reference to the screen shots illustrated in FIG. 3.

The described operations of FIG. 2 and other figures may be accomplished using some or all of the system components described in detail above and, in some implementations, various operations may be performed in different sequences. In other implementations, additional operations may be performed along with some or all of the operations shown in FIG. 2 and the other figures. In yet other implementations, one or more operations may be performed simultaneously. In yet other implementations, one or more combinations of various operations may be performed. Some implementations may not perform all of the operations described with relation to FIG. 2 and other figures. Accordingly, the operations described are exemplary in nature and, as such, should not be viewed as limiting.

In some embodiments, the operations described in FIG. 2 and the other figures may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations described in FIG. 2 and the other figures in response to instructions stored electronically on an electronic storage medium. The one or more processing devices may include one or more devices configured through hardware, firmware, and/or software to be specifically designed for execution of one or more of the operations described in FIG. 2 and the other figures.

The screenshots illustrated in FIG. 3 and other drawing figures are for illustrative purposes only. Various components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and, as such, should not be viewed as limiting. Interface 300 and other interfaces described herein may be implemented as a web page communicated from computing device 100 to a user computing device (e.g., user computing device 30a, 30b, . . . , 30n), a provider computing device (e.g., provider computing device 40a, 40b, . . . , 40n), an application such as a mobile application executing on a client computing device, provider computing device, and/or other computing device that receives generates the interface based on information communicated from computing device 100, and/or other interface. Whichever type of interface is used, computing device 100 may communicate the data and/or formatting instructions related to the interface to the client, causing the client computing device, provider computing device, and/or other computing device to generate the various interfaces of FIG. 3 and other drawing figures. Furthermore, computing device 100 may receive data from the client computing device, provider computing device, and/or other computing device via the various interfaces, as would be appreciated.

In an operation 202, a social networking forum for a cohort of users may be provided. The forum management module 110 may provide the social networking forum for the cohort of users. The forum management module 110 may provide the social networking forum for the cohort of users in a manner the same or similar as that described above.

In an operation 204, auction identification information for an auction for an item may be received from a supplier. The auction submission module 120 may receive auction identification information for an item offered for auction via the provided social networking forum. The auction submission module 120 may receive auction identification information in a manner the same or similar to that described above.

In an operation 206, an auction may be conducted via the social networking forum. The auction management module 130 may conduct the auction via the social networking forum. The auction management module 130 may conduct the auction in a manner the same or similar to that described above.

FIG. 3 illustrates an exemplary screenshot of an interface 300 that includes a template for system access, according to various implementations of the invention. In some implementations, user interface 300 may be presented that includes an exemplary template for system access. The template for system access may be presented to a user upon initial access of the system. The user interface 300 may include, for example, identification portion 302, navigation bar portion 304, forum portion 306, associated auctions portion 308, new auction portion 310, and/or other portions that display information.

In some implementations, identification portion 302 may display, for example, a user's name and a link via which the user may log out of the system. In some implementations, identification portion 302 may also include a link to the member's profile information, via which the member may view or edit profile information. In some implementations, navigation bar 304 may display one or more links to one or more templates available via the system 10. For example, the navigation bar 304 may display links related to the template for system access, a template for auction access, and/or other templates to present functionality to a member.

In some implementations, forum portion 306 may display a forum in which the member is joined. The forum may be displayed with information relating to the forum, a content feed of the forum, new content shared via the forum, and/or other information relating to the forum.

In some implementations, associated auctions portion 308 may display one or more display components by which the user may view associated auctions, view newly initiated auctions, search for an auction, and/or perform other functionality related to auctions. An individual auction may be displayed with information relating to the auction, a link to access the auction, and/or other information relating to the auction.

In some implementations, new auction portion 310 may display one or more display components by which the member may create an auction. For example, the new auction portion 310 may display one or more input components via which the member may input identification information for an item to be supplied, a minimum bid for the auction, a type of auction to be conducted, and/or other auction identification information related to the auction.

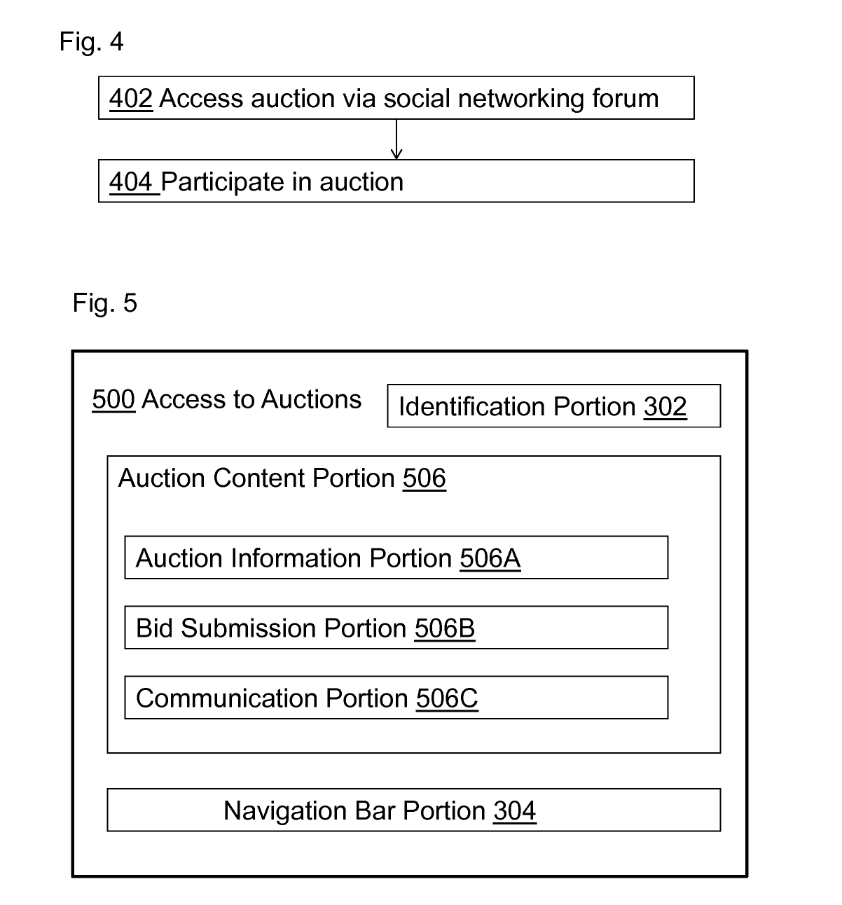

FIG. 4 illustrates a process for participating in an auction conducted via a social networking forum associated with a cohort of users, according to various implementations of the invention. FIG. 5 illustrates an exemplary screenshot of a template by which members of a forum may participate in an auction for an item, according to various implementations of the invention. Processing will be described with respect to FIG. 4 in reference to the screen shots illustrated in FIG. 5.

In an operation 402, one or more members of the forum may access an auction via a social networking forum. The auction management module 130 may facilitate accessing the auction. For example, the auction management module 130 may allow a member to search for an item and facilitate display of auctions related to that item. In another example, the auction management module 130 may facilitate receiving an indication from a member (e.g., by clicking a link related to the auction, and/or other indication) that the member would like to access the auction and may facilitate display of information related to the auction. The auction management module 130 may facilitate accessing the auction by one or more members of the forum in a manner the same or similar to that described above.

In an operation 404, one or more members of the forum may participate in an auction via a social networking forum. The auction management module 130 may facilitate participation by a member of the forum in the auction. The auction management module 130 may facilitate participation in the auction by a member of the forum in a manner the same or similar to that described above.

FIG. 5 illustrates an exemplary screenshot of an interface 500 that includes a template for access to auctions via a social networking forum, according to various implementations of the invention. In some implementations, user interface 500 may be presented that includes an exemplary template for forum access. The template for system access may be presented to a user upon initial access of the system. The user interface 500 may include, for example, identification portion 302, navigation bar portion 304, auction content portion 506, and/or other portions that display information.

In some implementations, auction content portion 506 may display information related to the auction, facilitate submission of bids, facilitate communication between participants in the auction and the supplier, and/or other information related to the auction. For example, forum content portion 506 may comprise one or more sub-portions, including auction information portion 506A, bid submission portion 506B, communication portion 506C, and/or other sub-portions.

In some implementations, auction information portion 506A may display information related to the item for auction, information related to a supplier of the item, information related to parameters of the auction, a predetermined number of bids most recently submitted, a current best bid, a member that submitted the current best bid, and/or other information related to the auction.

In some implementations, bid submission portion 506B may facilitate submission of a bid by a participant in the auction. For example, bid submission portion 506B may comprise one or more user display components that display a current best bid, a member that submitted the current best bid, a “buy now” price for the item, and/or other information related to bidding for the item. The bid submission portion 506B may also comprise one or more user input components configured to receive a bid for the item. For example, the bid submission portion 506B may comprise a user input component via which a member may authorize the system 10 to submit a bid better than the current bid responsive to the member's submitted bid being beaten, until an upper limit for bidding is met.

The communication portion 506C may facilitate social networking communications between participants in the auction. For example, communication portion 506C may display user input components and/or other user components by which a member may post content to the communication portion 506C and/or otherwise engage in social networking communications.

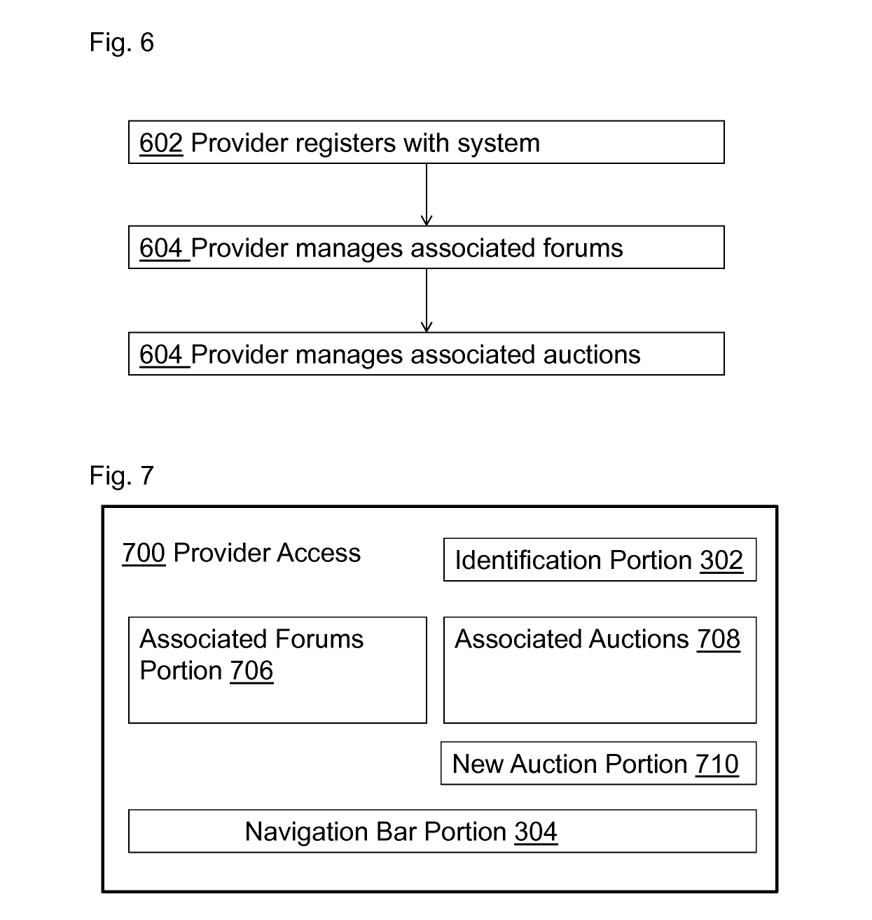

FIG. 6 illustrates a process for conducting an auction via social networking forum for a cohort of users, according to various implementations of the invention. FIG. 7 illustrates an exemplary screenshot of a template by which a provider of a shared experience may participate in an auction for an item, according to various implementations of the invention. Processing will be described with respect to FIG. 6 in reference to the screen shots illustrated in FIG. 7.

In an operation 602, a provider may register with the system. The provider management module 140 may facilitate registration by the provider. The provider management module 140 may facilitate registration by the provider in a manner the same or similar as that described above.

In an operation 604, a provider may manage associated forums. The provider management module 140 may facilitate management, by the provider, of associated forums. The provider management module 140 may facilitate management, by the provider, of associated forums in a manner the same or similar to that described above.

In an operation 604, a provider may manage associated auctions. The provider management module 140 may facilitate management, by the provider, of associated auctions. The provider management module 140 may facilitate management, by the provider, of associated auctions in a manner the same or similar to that described above.

FIG. 7 illustrates an exemplary screenshot of an interface 800 that includes a template for provider access, according to various implementations of the invention. In some implementations, user interface 700 may be presented that includes an exemplary template for provider access. The template for provider access may be presented to a provider upon initial access of the system. The user interface 700 may include, for example, identification portion 302, navigation bar portion 304, associated forums portion 706, associated auctions portion 708, new auction portion 710, and/or other portions that display information.

In some implementations, associated forums portion 706 may display one or more forums associated with respective one or more cohorts for which the provider provides the shared experience. The forums may be displayed with information relating to the forum, a link to access the forum, new content shared via the forum, functionality provided via the forum, an ability to edit functionality provided via the forum, third parties with access to the forum, an ability to edit third party access to the forum, and/or other information relating to the forum.

In some implementations, associated auctions portion 708 may display one or more display components by which the provider may view associated auctions, view newly initiated auctions, search for an auction, and/or perform other functionality related to auctions. The auctions may be displayed with information relating to the auction, a link to access the auction, and/or other information relating to the auction.

In some implementations, new auction portion 710 may display one or more display components by which the provider may create an auction. For example, the new auction portion 710 may display one or more input components via which the provider may input identification information for an item to be supplied, a minimum bid for the auction, a type of auction to be conducted, and/or other auction identification information related to the auction.

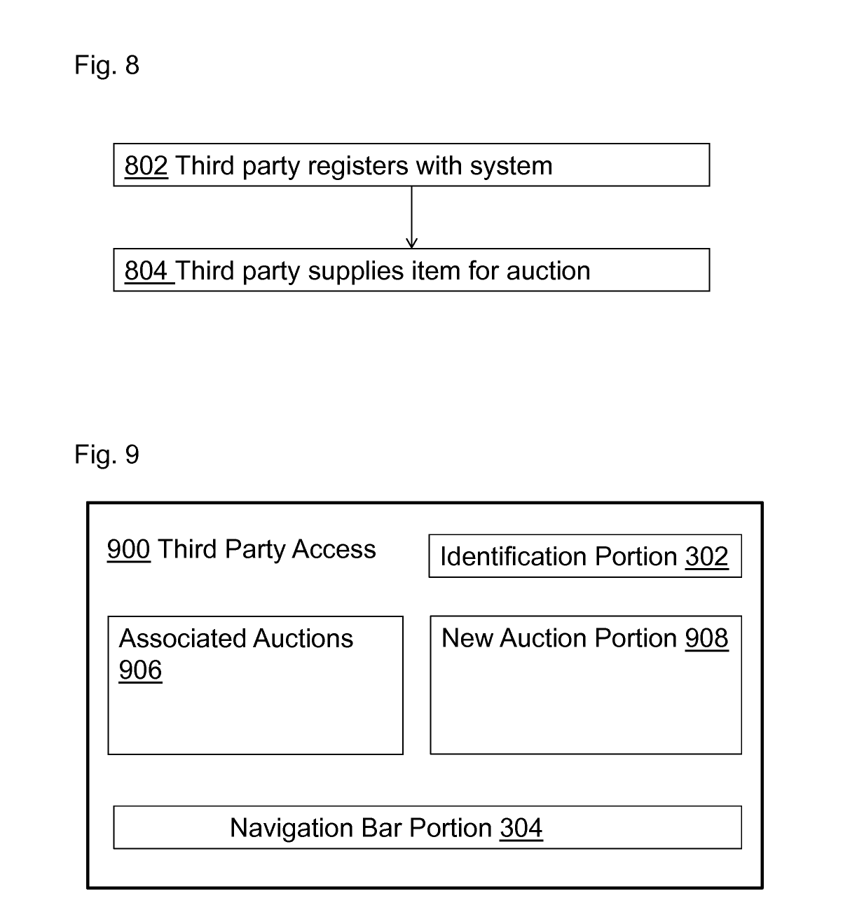

FIG. 8 illustrates a process for conducting an auction via social networking forum for a cohort of users, according to various implementations of the invention. FIG. 9 illustrates an exemplary screenshot of a template by which a third party may participate in an auction for an item, according to various implementations of the invention. Processing will be described with respect to FIG. 8 in reference to the screen shots illustrated in FIG. 9.

In an operation 802, a third party may register with the system. The third party management module 150 may facilitate registration by the provider. The third party management module 150 may facilitate registration by the third party in a manner the same or similar as that described above.

In an operation 804, a third party may participate in an auction. The third party management module 150 may facilitate participation, by the third party, in an auction. The third party management module 150 may facilitate participation by a third party in an auction in a manner the same or similar to that described above.

FIG. 9 illustrates an exemplary screenshot of an interface 900 that includes a template for third party access, according to various implementations of the invention. In some implementations, user interface 900 may be presented that includes an exemplary template for third party access. The template for third party access may be presented to a third party upon initial access of the system. The user interface 900 may include, for example, identification portion 302, navigation bar portion 304, associated auctions portion 906, new auction portion 908, and/or other portions that display information.

In some implementations, associated auctions portion 906 may display one or more display components by which the third party may view associated auctions, view newly initiated auctions, search for an auction, and/or perform other functionality related to auctions. The auctions may be displayed with information relating to the auction, a link to access the auction, and/or other information relating to the auction.

In some implementations, new auction portion 908 may display one or more display components by which the third party may create an auction. For example, the new auction portion 710 may display one or more input components via which the third party may input identification information for an item to be supplied, a minimum bid for the auction, a type of auction to be conducted, and/or other auction identification information related to the auction.

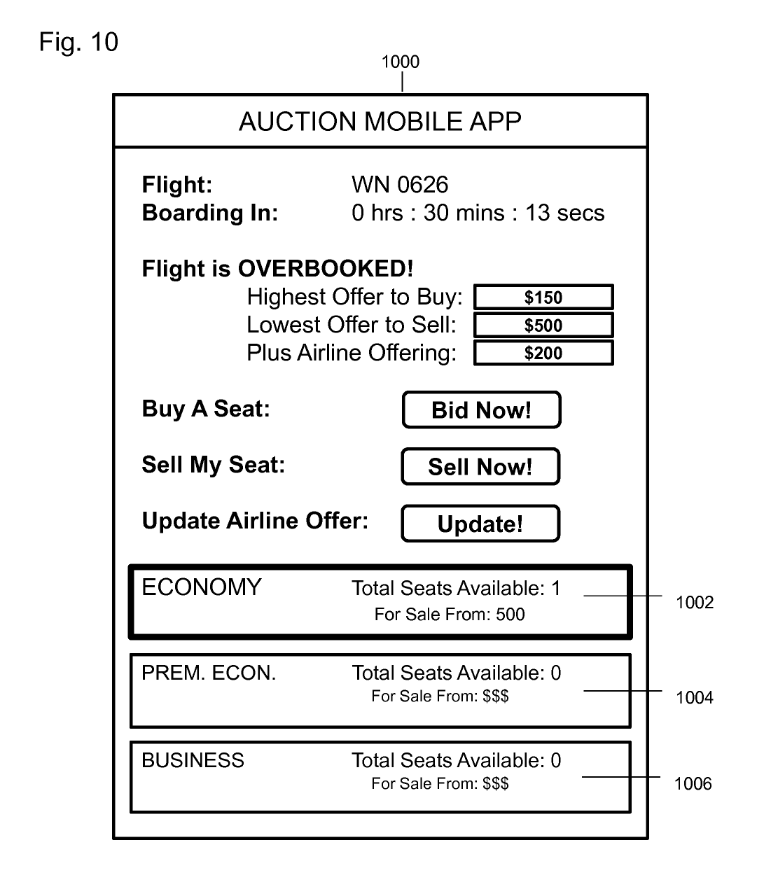

FIG. 10 illustrates an exemplary user interface 1000 for participating in an auction, according to various implementations of the invention. As shown in FIG. 10, user interface 1000 may enable a user (e.g., a buying user, a selling user, etc.) to participate in a two-way auction for plane tickets. The user interface 1000 may, for example, enable a user to submit an offer to buy a plane ticket associated with a seat on the flight, submit an offer to sell a plane ticket associated with a seat on the flight, update an airline offer associated with plane tickets, view the current highest offer to buy for each plane ticket type (e.g., economy, premium economy, business, first class, etc.), view the lowest offer to sell for each plane ticket type, view the number of tickets available for sale for each plane ticket type, or perform other actions. In one scenario, as illustrated by user interface 1000, the flight may be overbooked. In such a scenario, the service associated with the user interface 1000 (e.g., auction service) may nevertheless enable users to buy tickets from passengers currently scheduled for transit on the flight (or other entity selling on behalf of the passengers), as well as enable the passengers (e.g., selling users) to sell their tickets, via the two-way auctioning process. In one implementation, the service may pair a buyer and a seller as soon as they agree on a price through the auctioning process (e.g., when their respective offer to buy and offer to sell converges, when one user accepts the offer of the other user, etc.). Nonetheless, because there may be multiple buyers and/or multiple sellers, the two-way auction (e.g., related to a same plane ticket type) may continue so that other buyers and sellers can continue to make offers to buy tickets and offers to sell tickets.

In one use case, with respect to FIG. 10, a selling user may participate in a two-way auction for economy seating plane tickets. The selling user may, for example, be a passenger currently scheduled for transit in economy seating on the flight (or other entity selling on behalf of the passenger). As indicated, the “Sell Now!” button enables the selling user to offer his/her ticket for sale (e.g., at a price greater than the current highest offer to buy) and/or to accept the current highest offer to buy. If, for example, the selling user's offer to sell his/her economy seating ticket converges with a buying user's offer to buy an economy seating ticket, then the two offers may be used to execute a transaction to buy/sell the selling user's economy seating ticket. For example, if the selling user offer to sell is $200, and the buying user's offer to buy is $300, a transaction to buy/sell at a price of $250 (e.g., an average of the two offers) may be executed, and the ownership of the plane ticket may be transferred from the selling user to the buying user. In another example, the transaction price may be biased toward favoring the selling party such that the transaction is executed at a price closer or equal to the buying user's offer to buy (e.g., a transaction price of $300 or some other price greater than $250). In yet another example, the transaction price may be biased toward favoring the buying party such that the transaction is executed at a price closer or equal to the selling user's offer to sell (e.g., a transaction price of $200 or some other price less than $250).

In another use case, with respect to FIG. 10, a selling user may participate in a two-way auction for business seating plane tickets. The selling user may, for example, be a passenger currently scheduled for transit in business seating on the flight (or other entity selling on behalf of the passenger). As shown, the user interface 1000 is currently showing options for buying and selling economy seating tickets (e.g., the economy seating section 1002 is highlighted, while other sections 1004 and 1006 are not highlighted)). The selling user may thus activate the options for buying and selling business seating tickets (e.g., by selecting the business seating section 1006), and using the corresponding “Sell Now!” button to offer his/her ticket for sale.

In yet another use case, with respect to FIG. 10, a buying user may participate in a two-way auction for economy seating plane tickets. As indicated, the “Buy Now!” button enables the buying user to offer to buy an economy seating plane ticket (e.g., at a price less than the current lower offer to sell) and/or to accept the current lowest offer to sell. If, for example, the buying user's offer to buy an economy seating ticket converges with a selling user's offer to sell an economy seating ticket, then the two offers may be used to execute a transaction to buy/sell the selling user's economy seating ticket. For example, if the buying user's offer to buy is $300, and if the selling user offer to sell is $200, a transaction to buy/sell at a price of $250 (e.g., an average of the two offers) may be executed, and the ownership of the plane ticket may be transferred from the selling user to the buying user. It should be noted that, while two-way auctions for plane tickets are described with respect to FIG. 10, other types of auctions may be used, and/or other items may be auctioned, in other implementations.

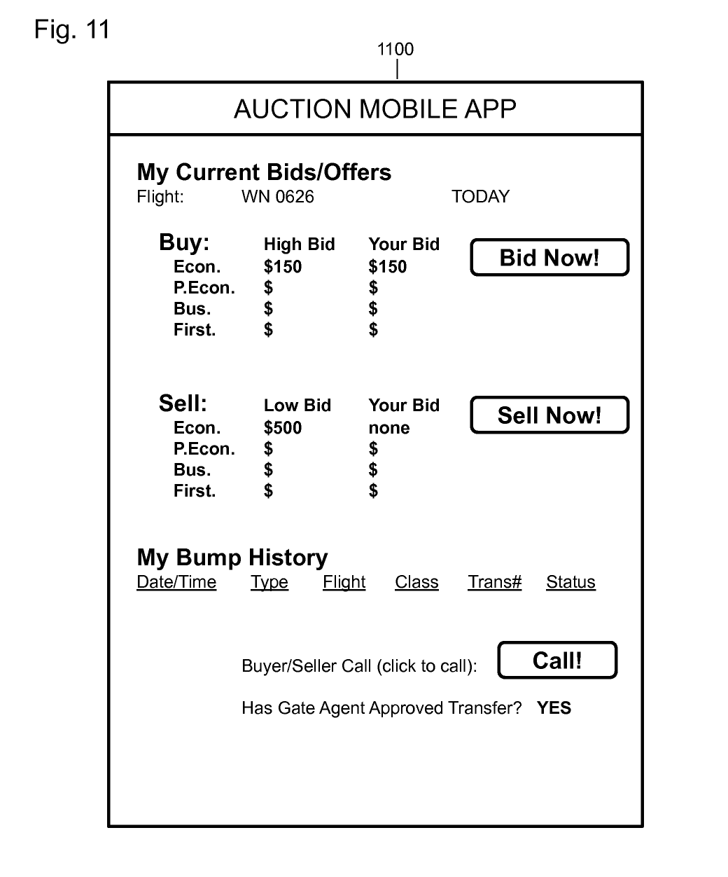

FIG. 11 illustrates an exemplary user interface 1100 for enabling a user to view current bids of the user, offers for the user, and transaction history, according to various implementations of the invention. As shown in user interface 1100, the user has previously submitted an offer (that is currently active) to buy an economy seating plane ticket for a particular flight. The user may, for example, change his/her offer by selecting the “Bid Now!” button, and/or submit an offer to sell a plane ticket for the flight by selecting the “Sell Now!” button. In one use case, with respect to FIG. 11, if the buying user's offer to buy at $150 converges with a selling user's offer to sell, a transaction to buy/sell may be executed, and the ownership of the plane ticket may be transferred from the selling user to the buying user.

In one implementation, users that indicate an interest to be a part of a scheduled experience may be associated with the scheduled experience. By way of example, with respect to FIGS. 10 and 11, a buying user may be associated with a scheduled flight when the buying user initiates one or more steps to purchase a plane ticket for the scheduled flight. The buying user may, for instance, have a pre-established association with the scheduled flight if the buying user: (i) searched for plane tickets for flights with a similar (or the same) departure location and/or a similar (or the same) destination location; (ii) submitted a request to purchase a plane ticket for the scheduled flight; (iii) previously purchased a plane ticket for the scheduled flight; or (iv) performed other steps indicating an interest in the scheduled flight. As such, upon being associated with the scheduled flight, the buying user may be invited to join a social networking forum associated with the scheduled flight. Upon joining the social networking forum, the buying user may be invited to participate in auctions for plane tickets associated with the scheduled flight.

As another example, with respect to FIGS. 10 and 11, a selling user may be associated with a scheduled flight by virtue of the selling user having his/her plane ticket for the scheduled flight. Upon being associated with the scheduled flight, the selling user may be invited to join a social networking forum associated with the scheduled flight. Upon joining the social networking forum, the selling user may be invited to participate in auctions for plane tickets associated with the scheduled flight.

In another implementation, users may be associated with a scheduled experience when the user is registered to partake in the scheduled experience. In one use case, with respect to FIGS. 10 and 11, a buying user is associated with a scheduled flight when the buying user purchases a plane ticket to be a passenger of the scheduled flight. Thus, for instance, the buying user may have previously purchased a plane ticket to be a passenger of the scheduled flight and is now seeking to purchase a second plane ticket (on behalf of another passenger) for the scheduled flight. Upon being associated with the scheduled flight, the buying user may be invited to join a social networking forum associated with the scheduled flight. Upon joining the social networking forum, the buying user may be invited to participate in auctions for plane tickets associated with the scheduled flight.

In another use case, with respect to FIGS. 10 and 11, a selling user is associated with a scheduled flight when the selling user purchases a plane ticket to be a passenger of the scheduled flight. Upon being associated with the scheduled flight, the selling user may be invited to join a social networking forum associated with the scheduled flight. Upon joining the social networking forum, the selling user may be invited to participate in auctions for plane tickets associated with the scheduled flight.

The computing device 100 may be any computing device such as, for example, a server, a desktop computer, laptop computer, personal digital assistant, smart phone, and/or any other computing device. Other configurations and system architectures may be used. For example, although not shown, computing device 100 may be or include one or more servers connected to one or more clients via a network 20 such as a Wide Area Network, Local Area Network, the Internet, a cloud-based network and/or other network or combination thereof. The computing device 100 may be capable of communicating with network 20, storage module 105 and one or more other devices, such as one or more user computing devices and/or one or more provider computing devices.

A user computing device 30n may facilitate communication with the computing device. For example, a user may communicate with the computing device 100 via a user computing device 30n. In some implementations, the term user may be interchangeably used herein with the term user computing device. In some implementations, the term member may also be interchangeably used herein with the term user computing device. In some implementations, a user's actions and/or functionality as described herein may be carried out and/or implemented by a user computing device 30n. In some implementations, a member's actions and/or functionality as described herein may be carried out and/or implemented by a user computing device 30n. The user computing device 30n may be any computing device such as, for example, a server, a desktop computer, laptop computer, personal digital assistant, smart phone, and/or any other computing device. The user computing device 30n may be capable of communicating with network 20, computing device 100, the storage module 105, and one or more other devices.

A provider computing device 40n may facilitate communication with the computing device 100. For example, a provider may communicate with the computing device 100 via a provider computing device 40n. In some implementations, the term provider may be interchangeably used herein with the term provider computing device. In some implementations, a provider's actions and/or functionality as described herein may be carried out and/or implemented by a provider computing device 40n. A provider computing device 40n may be any computing device such as, for example, a server, a desktop computer, laptop computer, personal digital assistant, smart phone, and/or any other computing device. The provider computing device 40n may be capable of communicating with network 20, computing device 100, the storage module 105, and one or more other devices.

The storage module 105 may be at least one database that stores system data such as data related to system usage, one or more cohorts, one or more forums, one or more auctions, third parties, and/or or any other data. The storage module 105 may be associated and communicate with the computing device 100.

The one or more databases comprising the storage module 105 may be, include, or interface to, for example, an Oracle™ relational database sold commercially by Oracle Corporation. Other databases, such as Informix™, DB2 (Database 2) or other data storage, including file-based, object, or query formats, platforms, or resources such as OLAP (On Line Analytical Processing), SQL (Standard Query Language), NoSQL, a SAN (storage area network), Microsoft Access™ or other form of database may also be used, incorporated, or accessed. The database may comprise one or more such databases that reside in one or more physical devices and in one or more physical locations. The database may store a plurality of types of data and/or files and associated data or file descriptions, administrative information, or any other data.

In some implementations, the storage module 105 may be part of or hosted by a computing device on the network 20. In some implementations, the storage module 105 may be part of or hosted by the computing device 100. In some implementations, the storage module 105 may be physically separate from the computing device 100 but may be operably communicable therewith.

In some implementations, the storage module 105 may comprise electronic storage media that electronically stores information. The storage module 105 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The storage module 105 may include one or more virtual storage resources (e.g., cloud storage, a virtual private network, and/or other virtual storage resources). The storage module 105 may store software algorithms, information determined by processor 101, information received from computing device 100, information received from user computing devices 30a, 30b, . . . 30n, information received from provider computing devices 40a, 40b, . . . 40n, information received from third parties, and/or other information that enables computing device 100 to function as described herein.

Processor(s) 101 is configured to provide information processing capabilities in computing device 100. As such, processor 101 may include one or more of a digital processor, an analog processor, a digital circuit designed to process information, an analog circuit designed to process information, a state machine, and/or other mechanisms for electronically processing information. Although processor 101 is shown in FIG. 1 as a single entity, this is for illustrative purposes only. In some implementations, processor 101 may include a plurality of processing units. These processing units may be physically located within the same device, or processor 101 may represent processing functionality of a plurality of devices operating in coordination. The processor 101 may be configured to execute modules 110, 120, 130, 140, 150, 160, 170, and/or 199. Processor 101 may be configured to execute modules 110, 120, 130, 140, 150, 160, 170, and/or 199 by software; hardware; firmware; some combination of software, hardware, and/or firmware; and/or other mechanisms for configuring processing capabilities on processor 101.

It should be appreciated that although modules 110, 120, 130, 140, 150, 160, 170, and/or 199 are illustrated in FIG. 1 as being co-located within a single processing unit, in implementations in which processor 101 includes multiple processing units, one or more of modules 110, 120, 130, 140, 150, 160, 170, and/or 199 may be located remotely from the other modules. The description of the functionality provided by the different modules 110, 120, 130, 140, 150, 160, 170, and/or 199 described below is for illustrative purposes, and is not intended to be limiting, as any of modules 110, 120, 13, 140, 150, 160, 170, and/or 199 may provide more or less functionality than is described. For example, one or more of modules 110, 120, 130, 140, 150, 160, 170, and/or 199 may be eliminated, and some or all of its functionality may be provided by other ones of modules 110, 120, 130, 140, 150, 160, 170, and/or 199. As another example, processor 101 may be configured to execute one or more additional modules that may perform some or all of the functionality attributed below to one of modules 110, 120, 130, 140, 150, 160, 170, and/or 199.

In addition, implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of conducting an online auction where users of a cohort are participants of the online auction based on the users being part of the cohort, the method being implemented on a computer system that includes one or more physical processors executing one or more computer program instructions which, when executed, perform the method, the method comprising:
determining, by the computer system, a cohort associated with a scheduled experience, wherein the cohort comprises a plurality of users that have a pre-established association with the scheduled experience;
receiving, at the computer system, auction information related to an auction for one or more items;
associating, by the computer system, one or more users of the cohort as participants of the auction; and
conducting, by the computer system, the auction for the one or more items.

2. The method of claim 1, further comprising:
enabling, by the computer system, at least a subset of users of the cohort to join a social networking forum as members of the social networking forum based on a determination that the subset of users are part of the cohort,
wherein associating the one or more users as participants of the auction comprises associating the one or more users as participants of the auction based on a determination that the one or more users are members of the social networking forum.

3. The method of claim 2, further comprising:
obtaining, by the computer system, information related to the cohort prior to creating the social networking forum; and
creating, by the computer system, the social networking forum based on the information related to the cohort.

4. The method of claim 1, wherein the auction information comprises an end condition for the auction, which, when satisfied, indicates that the auction should end, the method further comprising:
ending, by the computer system, the auction based on a determination that the end condition has been satisfied.

5. The method of claim 4, wherein the end condition comprises an occurrence of the scheduled experience.

6. The method of claim 4, wherein the end condition comprises a predetermined amount of time passing after the auction begins.

7. The method of claim 4, wherein the end condition comprises a predetermined amount of time passing after a bid is received from a participant of the auction.

8. The method of claim 1, further comprising:
providing, by the computer system, information related to conducting the auction via a content feed of the social networking forum.

9. The method of claim 8, wherein providing information related to conducting the auction comprises providing, via the content feed of the social networking forum, information identifying at least one current bid associated with at least one item of the one or more items.

10. The method of claim 1, wherein a supplier of at least one item of the one or more items comprises at least one of a provider of the scheduled experience, a member of the social networking forum, or a third party that has access to the social networking forum, and wherein receiving the auction information comprises receiving, from the supplier, information related to the at least one item.

11. The method of claim 1, wherein a supplier of at least one item of the one or more items comprises a provider of the scheduled experience, and wherein receiving the auction information comprises receiving, from the provider, information related to the at least one item.

12. The method of claim 1, wherein a supplier of at least one item of the one or more items comprises a first member of the social networking forum, and wherein receiving the auction information comprises receiving, from the first member, information related to the at least one item.

13. The method of claim 1, wherein the auction comprises a one-way auction.

14. The method of claim 1, wherein the auction comprises a two-way auction.

15. A system for conducting an online auction where users of a cohort are participants of the online auction based on the users being part of the cohort, the system comprising:
one or more physical processors programmed with one or more computer program instructions which, when executed, cause the one or more physical processors to:
determine a cohort associated with a scheduled experience, wherein the cohort comprises a plurality of users that have a pre-established association with the scheduled experience;
receive auction information related to an auction for one or more items;
associate one or more users of the cohort as participants of the auction; and
conduct the auction for the one or more items.

16. The system of claim 15, wherein the one or more physical processors are further caused to:
enable at least a subset of users of the cohort to join a social networking forum as members of the social networking forum based on a determination that the subset of users are part of the cohort,
wherein associating the one or more users as participants of the auction comprises associating the one or more users as participants of the auction based on a determination that the one or more users are members of the social networking forum.

17. The system of claim 16, wherein the one or more physical processors are further caused to:
obtain information related to the cohort prior to creating the social networking forum; and
create the social networking forum based on the information related to the cohort.

18. The system of claim 15, wherein the one or more physical processors are further caused to:
end the auction based on a determination that the scheduled experience has occurred.

19. The system of claim 15, wherein a supplier of at least one item of the one or more items comprises a provider of the scheduled experience, and wherein receiving the auction information comprises receiving, from the provider, information related to the at least one item.

20. The system of claim 15, wherein a supplier of at least one item of the one or more items comprises a first member of the social networking forum, and wherein receiving the auction information comprises receiving, from the first member, information related to the at least one item.
